(19) United States
(12) Patent Application Publication
(10) Pub. No.: US 2006/0105311 A1
(43) Pub. Date: May 18, 2006

(54) Study aid

(76) Inventors: Vincent Immordino, Long Island, NY (US); Linda Vonhof, Long Island, NY (US)

Correspondence Address: COOPER & DUNHAM, LLP, 1185 AVENUE OF THE AMERICAS, NEW YORK, NY, 10036, US

(21) Appl. No.: 10/987,698

(22) Filed: Nov. 12, 2004

(51) Int. Cl. G09B 3/00

(52) U.S. Cl. 434/322

(57) ABSTRACT

This invention provides a study or memorization aid, comprising a case including a storage compartment for storing a plurality of question and answer wheels, the storage compartment including a base, a cover, and a hinge connecting the cover to the base, a display compartment for displaying one or more question and answer wheels, the display compartment having a base including a pair of windows disposed linearly on either side of a spindle, a pin extending upwardly from the base, a cover having a second pair of windows disposed linearly on the cover, a hinge connecting the cover to the base, and a cutout along an edge of the base for rotating an edge of the question and answer wheel, a hinge connecting the storage compartment to the display compartment, and a plurality of circular question and answer disks having a central aperture, and a arcuate slit adjacent the central aperture for engaging the pin, and question and answer indicia appearing on opposite sides of the aperture, and disposed such that the question and answer indicia appears in the windows in the display compartment when the disk is placed on the spindle.

### FIELD OF THE INVENTION

This invention relates to an educational device, and more particularly to an educational device which includes a storage cover, and a number of wheels having indicia printed on both sides thereof, preferably in question and answer format.

### BACKGROUND OF THE INVENTION

Many devices have been offered for use as study aids, including flash cards and rotatable disk assemblies to help students learn facts, vocabulary, arithmetic operations, and the like.

For example, U.S. Pat. No. 2,959,872 (Rodgers) provides an educational device with which one can create a story, learn the meaning of words, solve arithmetic problems, and the like. The device includes several multilayer leaves bound together along one edge. Each leaf includes two outer sheet layers and one inner rotating disk disposed there between, and pivotally mounted to one or more of the outer sheets. The outer sheets have cutouts formed to expose a specific portion of the sheet.

U.S. Pat. No. 2,386,082 (Attridge) provides a rotating disk device that replaces the metal eyelet or rivet with a pivot around which the disks can rotate inside the cover. The circular aperture is cut from the cover to form one or more fingers to hold the rotating disk in place.

U.S. Pat. No. 3,027,073 (Handelman) provides counters having a disk or disks rotating to bring different indicia or marking within or opposite a reference point such as a viewing window within a cover, which is particularly useful for keeping track of food and calorie intake. According to the patentee, the device has a base of plastic or cardboard folded or hinged to provide a back base and a cover or top. A grommet mounted on the base mounts two disks for concentric rotation thereon. The cover has one or more windows to expose a portion of disk. The second disk has a desired goal or stop limit.

U.S. Pat. No. 3,718,519 (Montgomery) provides a method of making flat rotating disk assemblies. The device has a folded cover that includes edge and window cut outs so that when structure assembled, it will expose edge of disk for easy turning. The disk has concentric center circle cut there from. Adhesive on both sides of center disk permits adhering it to the two cover portions.

Other approaches to rotating circular disc devices used for learning and related tasks include U.S. Pat. No. 4,626,220 (Kaufman); U.S. Pat. No. 4,920,033 (Hirsch); and U.S. Pat. No. 6,098,325 (Goldman). The disclosures of the foregoing patents are incorporated by reference herein in their entities.

The foregoing devices mostly lack disk interchangeability and storage compartments. Moreover, several have fixed or permanent enclosures need a separate casing or cover for each disk.

### SUMMARY OF THE INVENTION

The present invention overcomes the disadvantages of the prior devices by providing, in a preferred embodiment, a combination display and storage device for rotating learning disks, comprising: a case including a storage compartment for storing a plurality of question and answer wheels, the storage compartment including a base, a cover, and a hinge connecting the cover to the base; a display compartment for displaying a question and answer wheel, the display compartment having a base including a pair of windows disposed linearly on either side of spindle, a cover having a second pair of windows disposed linearly on the cover, a hinge connecting the cover to the base, and a cutout along an edge of the base for rotating an edge of the question and answer wheel; a hinge connecting the storage compartment to the display compartment; and a plurality of circular question and answer disks or wheels having a central aperture and question and answer indicia on opposite sides of the aperture, and disposed such that the question and answer indicia appears in the windows in the display compartment when the disk is placed on the spindle.

### BRIEF DESCRIPTION OF THE DRAWINGS

Further objects, features, and advantage of the present invention may be understood upon reviewing the following detailed description of the preferred embodiments, taken in conjunction with the attached drawings in which:

FIG. 1 is a front perspective view of the improved study aid of the present invention shown with the central hinge open;

FIG. 2 is a front elevation view of the improved study aid of the present invention with the storage and display case open, but with each compartment therein closed;

FIG. 3 is a front elevation view of the improved study guide of the present invention, shown with the center hinge and both compartments of the storage and display case in an open position;

FIG. 4 is a rear view of the display compartment in the improved study aid of the present invention; and

FIG. 5 is an example of a disk for use in the improved study aid of the present invention.

### DETAILED DESCRIPTION OF THE PREFERRED EMBODIMENT

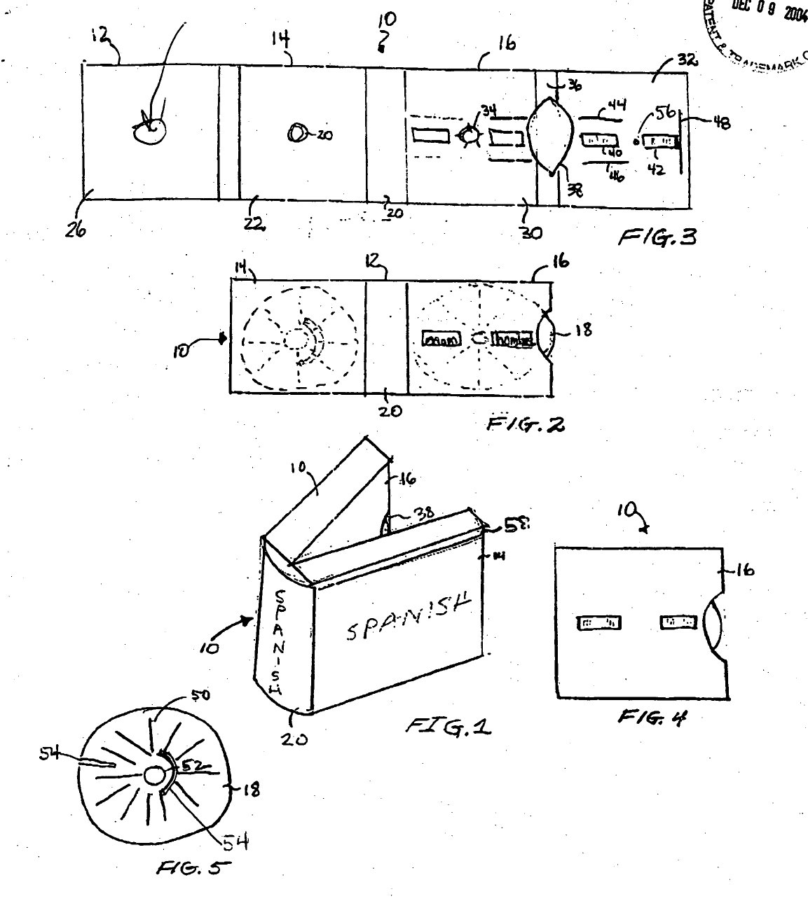

Referring to the drawings, FIGS. 1-4 illustrate the improved study aid of the present invention, generally designated by reference numeral 10. Briefly, the device generally includes a box 12 having a storage compartment 14 and a display compartment 16 for displaying question and answer indicia. The storage compartment 14 holds about twenty-five two-sided wheels 18 printed on card stock and the wheel compartment 16 holds a question wheel 18, preferably having indicia printed on both sides.

As shown in FIGS. 2 and 3, and as mentioned above, the box 12, preferably includes two main compartments: a storage compartment 14 for holding question and answer wheels 18 not in use, and a display compartment 16 holding one two-sided question and answer wheels or disks 18 for display and use, separated by a central hinge 20, which is preferably a living hinge. The storage compartment 14 includes a base 22 sized to hold and enclose several (up to about twenty-five) question and answer disks 18. A circular spindle 24 extending from the center of the base 22 holds the disks 18 in place in the storage compartment 14. A cover 26 for the storage compartment 14 lies on the other side of the base 22 from the storage compartment hinge 28, allowing the cover 26 to close the storage compartment 14.

The display compartment 16 also has a base 30, a cover 32 and a central spindle 34 to hold one or more question and answer disks 18. A longitudinal hinge 36 separates the base 30 from the cover 32. The hinge 36 includes a preferably oval cut out 38 to enable a user to rotate the edge of a disk 18. The cover 32, and optionally the base 30, further includes a pair of windows 40, 42, one to display a question, the other to display an answer. One window 40 on the cover 32 has a pair of ribs 44, 46 disposed above and below the window 40 to hold the disk 18 level, so that the windows and indicia line up properly, and so that the disk 18 turns smoothly, and stays in place. Likewise, a longitudinal rib 48 located near the second window 42 supports and levels the disk 18.

The question and answer rotating disk 18 is sized to fit within the storage 14 and display 16 compartments. The disk 18 has indicia 50 thereon in the form of words and meanings, or questions or problems and answers, and a central aperture 52, which fits on the spindle 34 in the storage and display compartments 14, 16. The disk 18 preferably has an arcuate slit 54 which cooperates with a pin 56 extending from the base 30 of display compartment 16 adjacent to the spindle 34 (see FIG. 3). The arcuate slit 54 aligns with the pin 56 to orient the disk 18 at the first question thereon, and to help keep the questions or other indicia 50 centered in the windows 40, 42 in the display compartment 16. Advantageously, when the disk 18 has traveled a complete revolution, and all of the questions or other indicia 50 thereon have been viewed, the disk 18 can be flipped, and the slit aligned with the tab 56 to start the second side of the disk 18 at the first question. Optionally, the disk 18 can have one entry thereon that says “turn over” after the last question.

The amount of indicia 50 on a disk 18 can be adjusted according to the subject matter involved, and the print and window size (in the display compartments) can also be adjusted, as necessary. The indicia 50 can relate to numerous subjects, facts, and problems, including, for example, vocabulary, foreign languages, arithmetic and other mathematics subjects, medical terminology, and for different ages, including nursery school, primary grades, secondary school, college and graduate school. Pictures may be used on one side or the other, where applicable to teach colors, spelling, animal names, and the like.

Preferably, the disks 18 and indicia 50 are formatted and printed using a computer program that prints the indicia, such as questions and answers in axial format, in order to make sure the indicia appears legible and centered in the windows 40, 42. Using the program, each window 40, 42 can accommodate from one word up to three lines of text, as well as graphics and pictures. The program helps to size, space and orient to text in an appropriate place on each side of the disk 18.

The dimensions of the disk 18 and the compartments 14, 16 can be varied according to the application and the age of the consumer. For example, for younger or older users, the size can be enlarged to permit addition of more information, and longer questions and answers, where desirable. In one embodiment, the disk is about 4¾ inches in diameter, and the compartments can be squares about 5 inches on a side. The storage compartment 14 is about a half inch deep, while the display compartment 16 is about a quarter inch deep. A typical window measures about 1½ inches long and about 1⅜ inches high.

It can be appreciated by a person of ordinary skill that an improved study and learning aid has been disclosed that provides many advantages over prior devices. For example, the present invention, with its internal storage capacity, protects the disks from damage. Further, it provides more flexibility by avoiding use of rivets and other permanent fasteners, which preclude interchange of disks. The invention also has windows on two sides of the display compartment, which enables use of double sided disks. The disks are printed to provide precise location of the indicia so that it can include more information, pictures, or graphics, and will appear centered in the windows. The package or case can stand or be stored on a bookshelf, without sacrificing its compactness. It may be made of rigid or flexible plastic, and may be opaque or transparent, depending on desired presentation. In addition, a pocket may be added to one or more sides of the exterior to show interchangeable printed material, to indicate (for example) on the disks contained inside.

Various improvements, modifications, and alterations of the invention as set forth herein may be made by one of ordinary skill without departing from the sprint or scope of the invention. It is intended that all such modifications and improvements be covered by the present invention as defined by the following claims.

What is claimed is:

1. A study or memorization aid, comprising:
a case including a storage compartment for storing a plurality of question and answer wheels, the storage compartment including a base, a cover, and a hinge connecting the cover to the base;
a display compartment for displaying one or more question and answer wheels,
the display compartment having a base including a pair of windows disposed linearly on either side of a spindle, a pin extending upwardly from the base, a cover having a second pair of windows disposed linearly on the cover, a hinge connecting the cover to the base, and a cutout along an edge of the base for rotating an edge of the question and answer wheel;
a hinge connecting the storage compartment to the display compartment; and
a plurality of circular question and answer disks having a central aperture, and a arcuate slit adjacent the central aperture for engaging the pin, and question and answer indicia appearing on opposite sides of the aperture, and disposed such that the question and answer indicia appears in the windows in the display compartment when the disk is placed on the spindle.

2. A study or memorization aid in accordance with claim 1, wherein the case is high density polyethylene and the hinge is a living hinge.

3. A study or memorization aid in accordance with claim 2, wherein the windows have clear plastic inserts.

4. A study or memorization aid in accordance with claim 3 wherein the disk has question and answer indicia appearing axially from the central aperture on both sides of the disk.
